(19) United States
(12) Patent Application Publication
(10) Pub. No.: US 2021/0298251 A1
(43) Pub. Date: Sep. 30, 2021

(54) SELF-WATERING CONTAINER AND SOIL AND HYDROGEL MIXTURE THEREFOR

(71) Applicant: Richard Dayan, Brooklyn, NY (US)

(72) Inventor: Richard Dayan, Brooklyn, NY (US)

(21) Appl. No.: 16/829,579

(22) Filed: Mar. 25, 2020

(51) Int. Cl. A01G 27/02; A01G 24/42

(52) U.S. Cl. CPC A01G 27/02; A01G 24/42

(57) ABSTRACT

Novel autonomous self-watering containers for growing plants and soil and hydrogel mixture therefor. The novel self-watering containers are filled with the specific soil and hydrogel mixture and filled with water. The soil and hydrogel mixture absorbs the water and slowly releases it to water the plants planted in the mixture over the next several weeks, requiring no supervision, interaction, or maintenance with the container. The self-watering container and soil and hydrogel mixture save water and labor costs associated with the required frequent maintenance of current plant growing systems.

### BACKGROUND

This invention relates to innovative non-hydroponic self-watering containers and planters, as well as a novel mixture of soil and hydrogel for the self-watering containers. Hydroponics, which is frequently used for self-watering planters, are based on growing the plants in water or water-based nutrient solution, which does not use soil. In hydroponics, plants grow in a soilless medium in hydroponic planters or containers. Hydroponics are frequently used for automated or semi-automated growing of plants, where the water or nutrient solution is pumped into the containers or planters containing the growing medium and the plants (specifically, the roots of the plants).

Typically-used hydroponic growing mediums are inert: they include rocks, pellets, or wool, for example. The roots of the plants, suspended in the inert medium, are in direct contact with water or water-based nutrient solution added or pumped into the hydroponic container. Hydroponics only uses water but does not use any hydrogel because it is bad for hydroponics: the hydroponic systems rely on pumps that can only pump water, not gel. The pumps will run dry and burn out.

Sometimes, the inert medium is mixed with water absorbent or hydrophilic sponges, or foams. Polymer hydrogel is commonly used with inert growth mediums: it absorbs water when the water is added and slowly releases the water over time to nourish the plants that are in the growth mediums mixed with hydrogel. The advantages of using polymers or hydrogel is that they conserve water. However, the amount of hydrogel currently used in potted soil container is small and added to the potting mix in very small amounts. Thus hydrogel in current potting mixtures adds very little, if any, extra water absorbing properties to the potting mix versus the potting mix without hydrogel. This is because the amount of hydrogel in the potting mix is too low and the hydrogel in it is only exposed to water for a few seconds while it drains out in a normal planter, not giving the hydrogel time to activate. Consequently, plants planted in these potting mixes in regular containers still need to be watered on a regular basis and do not benefit much from the hydrogel in the potting mix.

Hydroponic systems are used for their speed of plant growth, the precision in allocating the same amount of nutrients to each plant, and water conservation. Hydroponic systems are more efficient versus soil-based growing, and hydroponic growing systems have been known and used for many years.

However, hydroponics cannot be autonomously operated for more than a week or two weeks, and require more frequent oversight and supervision. A private grower, for example, cannot go on vacation for a month and leave his or her plants unsupervised. Likewise, even in a commercial growing environment, constant maintenance of hydroponic systems adds to the labor requirements and therefore the cost of the final crop, which is usually passed on to the consumer.

### DESCRIPTION OF PRIOR ART

Hydroponic watering and growing planters are available for growing plants. However, the currently manufactured commercial hydroponic planters are not very autonomous because they need refilling with water (or pumping the water), thus requiring frequent management. Hydroponic methods, depending on the type, can also be expensive. Regular soil-based container planters have different problems, such as soil compaction and over-watering.

What is needed are novel self-watering containers that are more autonomous than hydroponic systems and allow for longer periods of watering the growing plants without supervision or refilling with water. What is also needed is a self-watering container that will absorb and then slowly release the water, watering the plants. This is accomplished by using the combination of the self-watering containers of the present invention with a special soil and hydrogel mixture in specific proportions, enabling the self-watering containers to absorb and store and then release back the water, producing a time delayed watering effect. Additionally, because such self-watering containers save water and reduce the amount of labor required for managing the planters, the owners of the self-watering containers can save money on water bills and labor.

The self-watering containers of the present invention are just as easily usable as conventional hydroponic systems are, at marginal or no cost increase to the consumer. There is a need for innovative self-watering containers that absorb and store and then release the water to nourish the plants for plant germination and growth. Additionally, various self-watering containers can be used for exterior and interior house or building decoration.

The purpose of the self-watering device and soil and hydrogel mixture is to reduce plant watering from two times a week to one time every six weeks. After the self-watering container (which the Applicant sometimes refers to as “hydrogel planter”) is filled with water, the owner is even free to go on vacation because there is no need to do anything else to hydrate the plants for six weeks.

SUMMARY

This invention meets the current need for a superior type of self-watering container or planter that can be autonomous for 6-8 weeks, without any supervision. It is fully self-contained and it uses a stable, reliable, and reusable mixture of soil and hydrogel. Such a container or planter may be used for germinating, growing, and cultivating a wide range of commercial plants and crops, including cannabis, tomatoes, and ordinary household plants. This invention significantly reduces the labor costs associated with operating the self-watering container or planter and conserves water. It is only necessary to water the container once every several weeks, not twice a week. The hydroponic and other methods of self watering planters accomplish two weeks without oversight at most and have other draw backs, such as that the roots need time(1-2 weeks) to penetrate the soil to reach a reservoir. The container and system of the present invention work instantly and with every plant type, regardless of the plant root size. They are also useful for sprouting seeds.

The self-watering container of the present invention can also be used in a desert environment where the water is preciously scarce (especially if the container is sealed). The self-watering container is completely passive and requires no electricity to operate or maintain; thus it is completely independent of the electric grid.

In use, the self-watering container is filled with the novel soil and hydrogel mixture according to the disclosure of the present invention. The container is then filled up with water, and from that point on the container requires no refilling or maintenance for 6-8 weeks. The hydrogel absorbs the water poured into the container, and the water essentially turns into a solid. The hydrogel slowly shrinks over the next 45 days or longer, releasing water that nourishes the plants that are in the mixture of soil and hydrogel. The Applicant has experimented with hydroponic systems, but nothing works as well and as long as the self-watering container and soil/hydrogel mixture as in this invention because the hydroponic systems need to be watered twice per week.

A container, which can be cylindrical, triangular (i.e., having three walls), but is preferably rectangular or square in a cross-section (substantially a cuboid shape), with a bottom, four side walls going upward from the bottom and forming an opening of the container, and a removable optional top fitted to the opening of the container, so as to close the container securely when the top is fitted to the opening. There is an aperture at the bottom of the container, approximately at the center of the bottom. The aperture is preferably covered by a layer of aquatic rocks and one or more filters to allow for water and fertilizer run off without clogging the aperture. The container may be a plastic molded container (i.e., a one-piece container, with integral interconnected walls and bottom), which is the preferred configuration, or it may be constructed from separate parts: bottom and walls connected to or interlocking with the bottom. The walls can be circular (for a cylindrical container), or there can be three, four, five or more walls for a triangular, rectangular or square, pentagonal and so on container. The number of walls would depend on practical volume, storage, and transportation requirements, as well as the desired esthetic appeal of the final container.

The mixture of soil and hydrogel provides a nutrient-rich environment in which the plants can grow. Not only does the soil provide additional nutrients to the plants, but it also works in combination with the hydrogel to create a novel mixture that is capable of reliably and consistently retaining the water and watering the plants for 6-8 weeks without any supervision. Soil by itself passes the water through too quickly, and is thus not suitable for long-term self-watering planters. Pure polymers and hydrogels, on the other hand, also cannot be relied on for 6-8 weeks because, in a given preferred volume of the container, the water will have been released prior to that time (i.e., also too quickly)—the hydrogel will dehydrate faster without the insulating properties of the soil in the mix. However, that is not the main or only reason the Applicant does not use pure hydrogel: the main reason is that plants do not “like” to grow in pure hydrogel. The Applicant has conducted experiments trying to grow plants in pure hydrogel and found that hydrogel is good for keeping cut flowers alive for extended periods, but it is not good for actual plant growth. Specifically, the plant will stay alive longer in pure hydrogel than in regular soil, but it will not get any bigger or be able to bear fruit.

That is why it is possible to put cut flowers in a vase full of hydrogel and the flowers will keep longer on the table, but you it is not reasonably possible to grow a tomato plant in a vase full of pure hydrogel. The plant roots do not like to grow in that oxygen-poor environment, so the soil is necessary to space out the hydrogel and allow air to enter the root system. That is also the reason hydroponics systems use both air and water, and not just water. There are other reasons against using pure hydrogel. The plant gets its nutrients from the soil, not the hydrogel, and if the plant were to receive its nutrients from the hydrogel, those nutrients would be more concentrated as the hydrogel dried out, which would burn or kill the plants. Yet another reason not to use pure hydrogel is that the soil acts as the support framework for the plant, including the root system, so that, when the hydrogel dries out, the soil is left there to support the plant's weight and anchor it in the container.

The novel combination of the soil and hydrogel works to release the water over a significant period of time, provide the nutrient-rich soil to the plants, and generate visual appeal of soil versus plaint polymer, if desired. For example, a hexagonal container with a soil and hydrogel mixture will look more impressive and visually appealing under the light than a rectangular container. Hydroponics delivers nutrients via the water, but the hydrogel planter according to the disclosure of the present invention delivers nutrients via the soil, and only regular water is used.

The methods and compositions of manufacture known in the art can be used for manufacturing the containers and the tops, including plastic, metals, treated wood, or other non-water-permeable materials.

The time-delayed water release and growing processes can be repeated virtually infinitely. Simply refill the self-watering container with water and the container is ready for reusing. When the soil is depleted after multiple uses, simply add a slow-release fertilizer and fill the container with water. The self-watering container can be used for hundreds or even thousands of growing cycles, provided it is made from resilient materials. The soil and hydrogel mixture never needs to be replaced. The hydrogel planter uses only half as much fertilizer as a comparable-sized regular planter. The self-watering container (hydrogel planter) uses fertilizer more efficiently because there are less watering cycles which waste fertilizers to excessive run off.

### DRAWINGS

These features, aspects and advantages of the self-watering containers and planters, as well as a novel mixture of soil and hydrogel for the self-watering containers will become further understood with reference to the following description and accompanying drawings where

FIG. 1 is a perspective view of one embodiment (cuboid shape) of the novel self-watering container of the present invention;

FIG. 2 is a perspective view of another embodiment (cylindrical shape) of the novel self-watering container of the present invention;

FIG. 3 is a side cross-sectional view of the embodiment of the present invention illustrated in FIG. 1;

FIG. 4 is top view of the embodiment of the present invention illustrated in FIG. 1; and FIG. 5 is a bottom view of the embodiment of the present invention illustrated in FIG. 1.

### DESCRIPTION

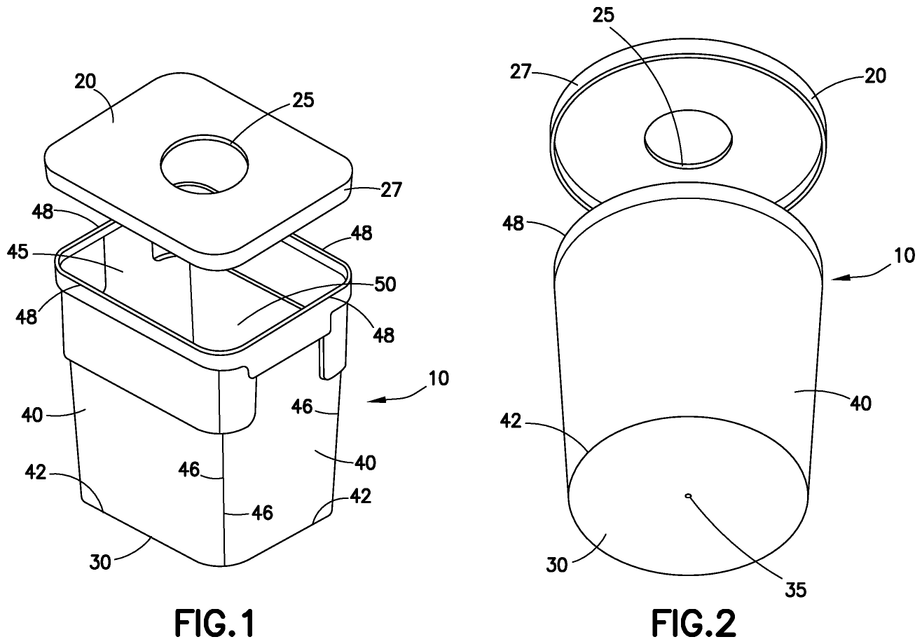

The present invention is directed to novel self-watering containers and soil and hydrogel mixture suitable therefor. With reference to FIGS. 1-3, the shape of the self-watering containers can be cylindrical, cuboid or substantially cuboid, polygonal or irregular polygonal, or other shapes suitable or desirable for the individual containers.

One such preferred embodiment is shown in FIG. 1 and FIGS. 3-10. With references to the drawings, and particularly FIGS. 1, 5-8, the preferred embodiment of the invention is a container 10 that has an optional top cover 20, a bottom 30 with an aperture 35, and four walls 40 extending between the top cover 20 and the bottom 30 where the walls 40 are permanently or detachably connected to the bottom 30. Each wall 40 has a lower edge 42 and an upper edge 48, and two side edges 46. The side edges 46 of each two adjacent walls 40 are permanently or detachably connected to each other. The lower edges 42 are connected to the bottom 30, and the upper edges 48 create an opening 45. The walls 40 define the interior volume 50 with the bottom 30, which interior volume 50 spans vertically from the bottom 30 to the opening 45.

As illustrated in FIG. 1, the top cover 20 is usually substantially flat or planar and may include an aperture 25, cut out or molded into the top cover 20. The top cover 20 is fitted to the opening 45 of the container 10 to securely close it or seal it when the top cover 20 is placed around the upper edges 48.

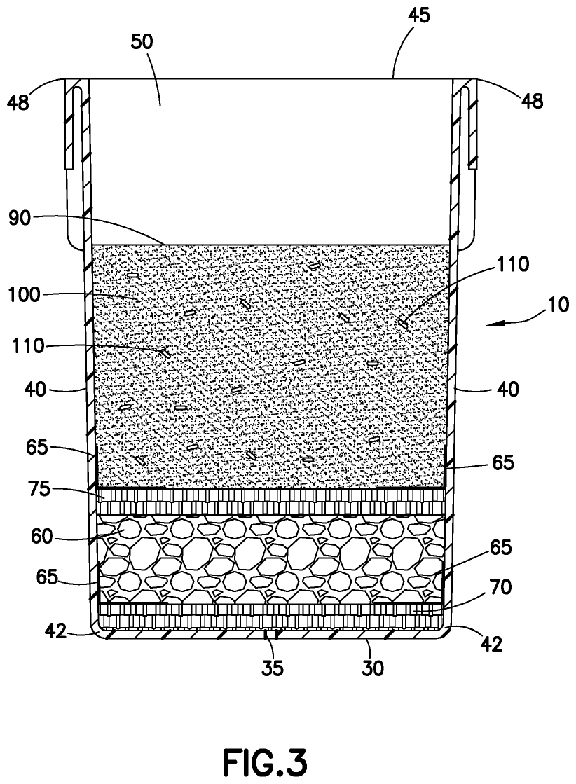

It should be noted that there may be one circular wall 40 as illustrated in FIG. 2, or three, four or more substantially flat or planar walls 40 for decorative purposes. Four walls 40 are illustrated in FIGS. 1 and 3, generating a substantially cuboid shape of the container 10. As shown in FIG. 1, the walls 40 may be tapered to facilitate stacking of multiple containers 10. In that case, the area of the bottom 30 will necessarily be smaller than the area of the top cover 20 and the opening 45. In use, the wall or walls 40 together with the bottom 30 define the internal volume 50 of the container 10.

With reference to FIG. 2, an alternative embodiment of the present invention may be a cylindrical shape container 10 that a top cover 20, a bottom 30 and one continuous wall 40 with the lower edge 42 and the upper edge 48 extending between the top cover 20 and the bottom 30, where the continuous wall 40 connects to the bottom 30, joining at the angle of substantially 90 degrees as illustrated in FIG. 2. As illustrated in FIGS. 1-2, the top cover 20 is usually substantially flat or planar and may include a tapered side 27 molded or otherwise built into the top cover 20 to assist with the fitting the top cover 20 over the opening 45. The container 10 may have a cylindrical, cuboid, or substantially cuboid shape as illustrated in FIGS. 1-2, but the containers 10 may also be manufactured in other irregular or fanciful shapes.

With reference to FIG. 3, the container 10 also includes the following internal elements, which are part of the novel growing system: a filter 75 located above approximately one inch of rocks 60, which are preferably river rocks or marble-sized aquatic substrate type rocks. Between one to two inches of rocks 60 may be used. The rocks 60 act as a second filter, and the filter 75 prevents the mixture of the soil and hydrogel 90 from entering the rocks 60 and the aperture 35. Without the filter 75, the mixture of the soil and hydrogel 90 would fill up the open air passages in the aquatic substrate (the rocks 60), especially when the water is flowing through the container 10, and block the drainage hole (aperture 35), causing the plant roots to rot and kill the plant. The filter 75 is placed on top of the rocks 60 and may additionally be secured to the interior sides of the walls 40 of the container 10 by the attachment means 65. Securing the filter 75 so as to close any gaps between the filter 75 and the walls 40 helps direct all of the draining water through the filter 75 and not around it, so this is the preferred method.

The system may also include an optional filter 70 securely attached to the bottom 30 or walls 40, overlapping and covering the aperture 35, but filter 70 is not required for the proper operation of the system, nor does filter 70 have to be attached to the bottom 30 or walls 40. In fact, the filter 70 may simply be placed on the bottom 70 within the interior volume 50 of the container 10, between the bottom 30 and the rocks 60. However, when filter 70 is used, securely attaching it to the bottom 30 or the walls 40 seals the gaps between the filter 70 and the walls 40 and/or bottom 30 of the container 10 and improves filtering. The function of the optional filter 70 is to further prevent the clogging of the aperture 35. Although the filter 70 may be attached both on the outside and on the inside of the container 10, for practical reasons it is preferred to attach the filter 70 on the inside of the container (i.e., within the interior volume 50).

The filters 70 and 75 are typically polyester pads, such as pond filters, 10-15 inches on each side, which allows for easy securing of the filter 70 to the bottom 30 and/or the walls 40 of the container 10 by adhesive tape, for example and the filter 75 to the walls 40. Smaller-size filters 70 may be used with attachment means 65 that do not require a large contact surface area. The aperture 35 is preferably 1/16 inch in diameter, although it may be varied appropriately to enable faster or slower drainage of water. The aperture 35 creates an hourglass-type outlet (extended-release drainage hole), holding the water in the hydrogel planter long enough for the hydrogel to absorb it, and allowing the hydrogel planter to flush salt and mineral build up as well as drain excess water through in approximately one hour.

The attachment of the filters 70 and 75 can be accomplished with attachment means 65 such as thermal bonding, adhesive, tape (duct tape or double-sided tape), hook and loop fasteners, buttons, snaps, stops, screws, bolts, latches, locks, straps, and rails or other methods known in the art, providing a permanent or semi-permanent attachment. Although the Applicant envisions that the filters can be permanently mounted, never needing replacement, the semi-permanent or detachable connection methods will allow for easy replacements of the filters. Alternatively, there can be a frame 80 with a pocket 85 mountable over the aperture 35, where the filter 70 is inserted into the pocket 85. This would make the filters easily replaceable, and the frame 80 could be attached by bolts, screws, rails, hook and loop fasteners, buttons, snaps, or other attachment means disclosed herein or known in the art to the bottom 30. The same method of mounting may be used for the filter 75, but the frame 80 would be placed and/or secured above the rocks 60 and may be optionally attached to the interior sides of the walls 40 of the container 10 by any attachment means 65.

The aperture 35 makes it possible for the excess water to drain off when the container 10 is filled with water. The filter 75 (and optional filter 70) makes it possible for the excess water to drain off when the container 10 is filled with water without clogging the rocks 60 and the aperture 35. The optional filter 70, when it is used, is covered on top by approximately one-two inches of rocks 60, preferably marble-sized aquatic substrate type rocks. The pond filter 75 is placed on top of the rocks 60 and may additionally be secured to the walls of the container 10 by attachment means 65. Accordingly, the filter 75 should preferably be approximately the same size as the lateral cross-sectional area of the container 10 approximately one-two inches above the bottom, depending on the thickness of the layer of rocks 60. The pond filter 75 prevents the rocks 60 and also the aperture 35 from being clogged by debris from the soil-hydrogel mix. The combination of the rocks 60 and filter 75, which cannot be permeated by the soil and hydrogel mix, also support the weight of the soil-hydrogel mix as well as allow open passageways for the filtered water to exit to the drainage hole (aperture 35). The filter 75 cleans the exiting water of debris so that it does not clog the drainage hole and contains the soil-hydrogel mix, separating the mix from the rocks 60 so that the passage ways remain open. The optional filter 70 does the final filtering of the exiting water so that the aperture 35 does not get clogged.

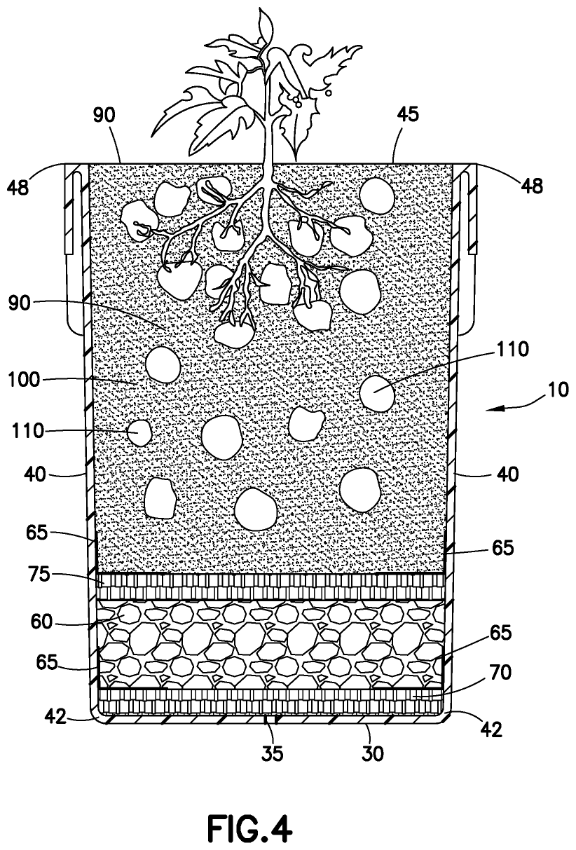

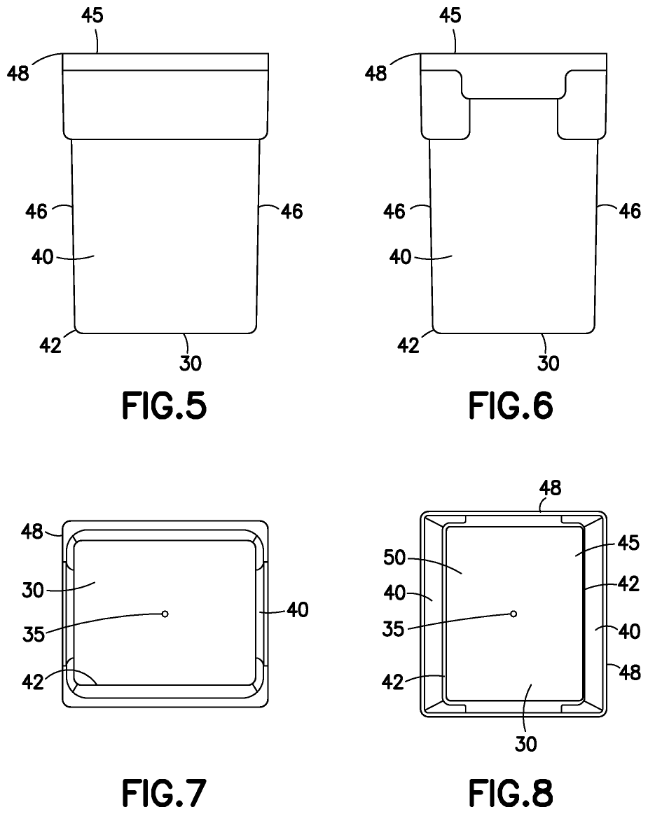

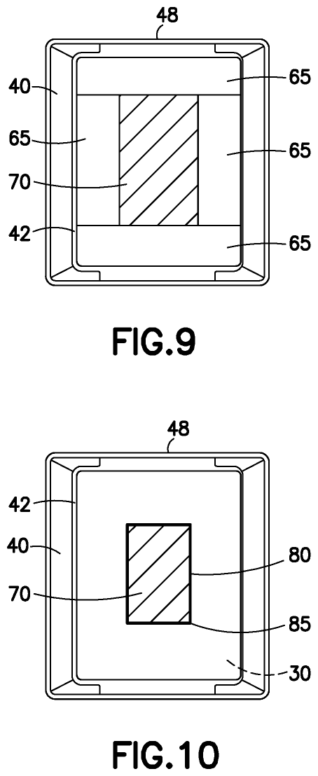

A special, novel mixture of the soil and hydrogel 90 is used to fill up the internal volume 50 of the container 10 for use. The mixture 90 contains soil 100 and hydrogel (preferably in granule form) 110. The soil 100 and hydrogel granules 110 are illustrated in FIGS. 3 and 4 (not to scale). The hydrogel granules 110 are small before the mixture 90 is watered as illustrated in FIG. 3, but the hydrogel granules 110 increase in size as they absorb water after being watered as illustrated in FIG. 4. FIG. 3 also illustrates the free space in the internal volume 50 before the mixture 90 is watered.

The container 10 is easily movable even when filled: if using a 13-gallon container, which is the preferred volume, the container filled with the mixture volume of 1.25 cubic feet, weighing approximately 31 pounds total (the dry weight of the 1.25 cubic feet of potting soil is 11 lbs.). The mixture is preferably 1.25 cubic feet of soil plus 2.5 lbs. of hydrogel, but the mixture still comes out to approximately the same volume of 1.25 cubic feet because the hydrogel is heavy and dense and the potting soil is light and fluffy. The volume of 2.5 lbs. of hydrogel separately from the soil is 101.5 cubic inches (0.059 cubic ft.), but, as explained in this application, the volume of the hydrogel is absorbed by the volume of the potting soil because the hydrogel is dispersed within the potting soil.

The container 10, once watered, stores 10 gallons of water as a solid in the soil-hydrogel mix. The container 10, fully filled with water, weighs 110 lbs. and holds ten gallons (79 lbs.) of water. Because the water turns into a solid when it is absorbed by the soil and hydrogel mixture, it does not evaporate as fast as regular water. This method and mixture also save water because ten gallons of water acts as 15 gallons. Small variations in the volume of soil are possible, reproducing similar results, but this proportion for the mixture of the soil and hydrogel 90 was found to be optimal by the Applicant.

The mixture of soil and hydrogel takes approximately one hour to absorb the ten (10) gallons of water and drain the excess. The container 10 (hydrogel planter) should be filled with 11 gallons of water every time it is watered. A very high concentration of hydrogel in the mix allows for this faster-than-normal water absorption rate of the hydrogel into the novel mixture of soil and hydrogel inside the container 10 allows. Normally, only 0.5 lbs. of hydrogel would be required to absorb 10 gallons of water, but it will take the hydrogel five hours to do so. In order for the hydrogel planter to absorb 10 gallons in one hour, it is necessary to increase the concentration of hydrogel in the mix by a factor of 5; therefore 2.5 lbs. of hydrogel only take one hour to absorb 10 gallons of water. The mixture 90 of soil 100 and hydrogel 110 expands during the absorption process and contracts during the release process. The expansion and contraction of the mixture 90 in a 13-gallon container is approximately seven inches vertically (as illustrated in FIG. 3, not-to-scale). Taking that into consideration, there is a particular mixture of soil to hydrogel, tailored to the container 10, particularly for the 13-gallon volume size.

Specifically, with reference to FIG. 1, the mixture 90 of the soil 100 and hydrogel 110 preferably comprises (by percentage of total volume and/or weight): 1.25 cubic ft. (35.4 liters) of soil 100 and 2.5 lbs. of hydrogel 110. As illustrated in FIG. 3, the overall resulting volume of the mixture 90 leaves seven to nine inches of space from the top edges 48 (and the opening 45) of the container 10 to the top of the mixture 90 level when the container 10 is dry (i.e., unfilled with water). If the mixture 90 level is higher, it will lower the amount of oxygen available to the roots when the container 10 is hydrated. After the container 10 is filled with water, and the water is absorbed by the soil and hydrogel mixture 90, the level of the mixture 90 will be on approximately the same level as the top of the container 10 because the mixture 90 will expand vertically seven inches when hydrated.

Although the preferred ratio of soil to hydrogel for the novel mixture 90 is 1.25 cubic ft. of soil 100 and 2.5 lbs. of hydrogel 110, the Applicant envisions a wider range of hydrogel for the given volume of soil 100 (1.25 cubic feet): anywhere from 2.5 to 3 lbs. of hydrogel 110 may be used per 1.25 cubic ft. of potting soil 100 in the mix, appropriately scaling for larger or smaller containers. Anywhere from 7 to 9 inches of space is required from the top of the container 10 to the top of the soil and hydrogel mix 90 when the mix 90 is dry.

Once the internal volume 50 of the container 10 is filled with the soil and hydrogel mixture 90 through the opening 45, water is added to the mixture 90 all the way to the top edges 48. Approximately 10% of the water will drain out of the aperture 35, which is essentially a drainage hole covered by the rocks 60, the pond filter 75, and possibly the optional filter 70, and 90% of the water will be absorbed by the soil 100 and hydrogel 110 mixture. This hydrated mixture 90 will keep the plants hydrated for six weeks at normal temperature; after that time the container 10 can be filled up with water to the top again to reuse the mixture.

The design of the hourglass drainage system, using the aperture 35, is to slow down the drainage to allow the time for the soil and hydrogel mixture 90 to absorb the water in the container 10. The mixture 90 has a very high amount of hydrogel 110 by design, to speed up the absorption of water process. The combination of the two systems allows the container/planter 10 to absorb roughly ten gallons of water in one hour. The soil and hydrogel mix is calibrated for the one-hour drain in the container 10, and either soil or hydrogel alone will not work without the other; the components of the mixture 90 are specifically formulated and designed for each other, taking factors like the container size and volume into account.

Many types of potting soil 100 may be used for the mixture 90, but it is preferable to use soil with a slow-release fertilizer added to it. This planter is designed to make growing plants, including cannabis, very easy, and it provides a stable environment for cannabis from seed to harvest. The internal volume 50 of the container 10 is filled with the soil and hydrogel mixture 90, which absorbed water, so the roots of the plants are instantly in contact with the water stored in the hydrogel 110. No other planter can last this long: six weeks is an incredibly long time, instead of constantly caring for a cannabis plant. This planter not only solves the watering problem, but also other soil container planter problems like soil compaction and over-watering. The roots are also never in contact with stagnating water. This is the only known self-watering planter that is deigned to be used with cannabis.

The proportion of the components may be selected by those skilled in the art depending on the desired end product and its characteristics, such as cost, durability, reusability, and other parameters, but of course the total proportion by weight or volume of all components must add to 100% in the end.

The container 10 may be manufactured from plastic, stainless steel, or other suitable materials well-known in the art that are sufficiently liquid-proof to retain the water and soil and hydrogel mixture 90, and to allow for slight expansion/contraction of the soil and hydrogel mixture 90 during the water absorption and release process, and to facilitate easy removal of the mixture from the container 10.

As disclosed herein, the mixture 90 of soil 100 and hydrogel 110 can be reused by filling the container 10 with 11 gallons of water again. However, when it is the time to add the fertilizer, the mixing of the soil and hydrogel mixture inside the container 10 is typically accomplished by using small gardening shovels, particularly when the growing is on a small-scale level. The Applicant has determined that only very small amounts of slow-release fertilizer need to be added to the mixture periodically: approximately ½ tsp every six months.

To operate the hydrogel planter at full capacity for one year (365 days), only eight watering events of 11 gallons each are required (using 88 gallons of water versus 156 gallons for a regular planter) and two applications of fertilizer at half of the normal amount (½ tsp twice per year), conserving water, saving time and labor, reducing costs and benefiting the environment with less water use and less fertilizer use and run off. Unrestrained fertilizer run off damages marine ecosystems and is responsible for uncontrolled growth of certain invasive marine algae and vegetation.

The hydrogel planter actually uses 75% less fertilizer than a conventional planter, even though it uses only half as much fertilizer, in view of that the fertilizer actually used lasts twice as long. Normally you need to add fertilizer every three months, but the hydrogel planter only requires it every six months, in addition to using only half the regular amount. So half of the amount of the fertilizer lasts twice longer than in a conventional planter, which would require 2 grams of fertilizer every three months for a total of 8 grams for every 12 months. The hydrogel planter according to the present invention only requires 1 gram every six months, or just 2 grams of fertilizer versus 8 grams for the conventional planter during the same 12 months.

By mixing the components, a mixture is obtained. In the commercial growing environment, where large batches of soil and hydrogel mixture must be prepared, shaking or vibrating the mixture on commercially available shakers or mixers ensures that the mixture is homogeneous. In the smaller-scale or home growing, the mixture can be mixed and homogenized by hand or with common garden tools.

The novel self-watering containers of the present invention may also be used in larger-size and more elaborate forms than those conventionally used for containers. Although a 13-gallon container is described in this application as the preferred embodiment, other size containers may be used. The 13-gallon container is commonly available, is easy to ship and store, and can accommodate even the large plants. However, it would be easy to use a container of a different size and to calculate the exact dimensions of the other system elements and the ratios of the soil and hydrogel mixture using the disclosure of the present invention.

The above description of the disclosed preferred embodiments is provided to enable any person skilled in the art to make or use the invention. Various modifications to these embodiments will be readily apparent to those skilled in the art, and the principles described herein can be applied to other embodiments without departing from the spirit or scope of the invention and the subject matter of the present invention, which is broadly contemplated by the Applicant. The scope of the present invention fully encompasses other embodiments that may be or become obvious to those skilled in the art.

What is claimed is:

1. A one-piece self-watering container and soil and hydrogel mixture comprising:
(a) A bottom having an aperture;
(b) at least three walls rising substantially vertically from the bottom, said at least three walls defining an internal volume of the one-piece self-watering container, each wall having a substantially horizontal upper edge, said upper edges forming an opening of the one-piece self-watering container;
(c) a layer of rocks disposed on the bottom in the internal volume;
(d) a filter disposed on the layer of rocks in the internal volume; and
(e) a soil and hydrogel mixture comprising 2.5 to 3.0 pounds of hydrogel per approximately 1.25 cubic feet of soil disposed on top of the filter in the internal volume.

2. The one-piece self-watering container and soil and hydrogel mixture of claim 1, further comprising attachment means securing the filter to the at least three walls so as to close any gaps between the filter and the at least three walls.

3. The one-piece self-watering container and soil and hydrogel mixture of claim 1, wherein the layer of rocks is one to two inches thick.

4. The one-piece self-watering container and soil and hydrogel mixture of claim 1, wherein the at least three walls are four walls.

5. The one-piece self-watering container and soil and hydrogel mixture of claim 1, wherein the walls are tapered to facilitate stacking of multiple empty containers.

6. The one-piece self-watering container and soil and hydrogel mixture of claim 1, further comprising a cooperating top cover fitted to the opening.

7. The one-piece self-watering container and soil and hydrogel mixture of claim 1, further comprising a second filter disposed between the bottom and the layer of rocks in the interior volume.

8. The one-piece self-watering container and soil and hydrogel mixture of claim 7, further comprising attachment means securing the second filter to the bottom or the at least three walls so as to close any gaps between the filter and the bottom or at least three walls.

9. The one-piece self-watering container and soil and hydrogel mixture of claim 1, wherein the filter is a polyester pad.

10. The one-piece self-watering container and soil and hydrogel mixture of claim 1, further comprising a frame cooperatively sized to accept the filter and securely containing the filter, said frame being disposed on the layer of rocks.

11. The one-piece self-watering container and soil and hydrogel mixture of claim 10, further comprising attachment means securing the frame to the at least three walls so as to close any gaps between the frame and the at least three walls.

12. The one-piece self-watering container and soil and hydrogel mixture of claim 1, wherein the interior volume is 13 gallons and wherein the soil and hydrogel mixture includes approximately 1.25 cubic feet of soil and 2.5 pounds of hydrogel, leaving seven to nine inches of space at the top of the interior volume for expansion of the soil and hydrogel mixture when the one-piece self-watering container is filled with water.

13. The one-piece self-watering container and soil and hydrogel mixture of claim 2, wherein the attachment means are selected from a group consisting of thermal bonding, adhesive, duct tape, double-sided tape, hook and loop fasteners, buttons, snaps, stops, screws, bolts, latches, locks, straps, and rails.

14. A method of watering plants, comprising the steps of:
(a) providing a self-watering container with a bottom having an aperture and at least three walls rising substantially vertically from the bottom, said at least three walls defining an internal volume of the self-watering container, each wall having a substantially horizontal upper edge, said upper edges forming an opening of the one-piece self-watering container;
(b) placing a layer of rocks on the bottom in the internal volume;
(c) placing a filter on the layer of rocks in the internal volume;
(d) filling most of the internal volume with a soil and hydrogel mixture comprising 2.5 to 3.0 pounds of hydrogel per approximately 1.25 cubic feet of soil through the opening, so that the soil and hydrogel mixture is disposed on top of the filter in the internal volume;
(e) placing plants into the soil and hydrogel mixture;
(f) filling the self-watering container with water;
(g) allowing the water to be absorbed by the hydrogel in the soil and hydrogel mixture; and
(h) allowing the slow release of water from the hydrogel into the soil and hydrogel mixture to nourish the plants over an extended period of time.

15. The method of watering plants of claim 15, further comprising the step of allowing excess water to drain through the aperture after filling the self-watering container with water.

16. The method of watering plants of claim 15, further comprising the step of adding slow-release fertilizer when the soil and hydrogel mixture is depleted of nutrients.

17. A combination self-watering container and soil and hydrogel mixture comprising:
(a) A bottom having a small drainage aperture therein;
(b) at least three walls, each having a substantially horizontal upper edge and a substantially horizontal lower edge and two substantially vertical side edges between the substantially horizontal upper edge and the substantially horizontal lower edge, wherein the at least three walls are connected to the bottom at each respective substantially horizontal lower edge and each of the at least three walls is connected to two adjacent walls of the at least three walls at the substantially vertical side edges, the at least three walls defining an internal volume of the self-watering container and forming an opening of the self-watering container defined by the substantially horizontal upper edge of each of the at least three walls;
(c) a layer of rocks disposed on the bottom in the internal volume, covering the aperture;
(d) a filter disposed on the layer of rocks in the internal volume, wherein the filter is secured to each of the at least three walls by attachment means so as to close any gaps between the filter and each of the at least three walls; and
(e) a soil and hydrogel mixture comprising 2.5 to 3.0 pounds of hydrogel per approximately 1.25 cubic feet of soil disposed on top of the filter in the internal volume.

18. The self-watering container and soil and hydrogel mixture of claim 17, wherein connections between the bottom and each of the at least three walls and between each of the at least three walls and the two adjacent walls are watertight.

19. The one-piece self-watering container and soil and hydrogel mixture of claim 1, wherein the layer of rocks is one to two inches thick.

20. The one-piece self-watering container and soil and hydrogel mixture of claim 1, further comprising a second filter disposed between the bottom and the layer of rocks in the interior volume.

21. A one-piece self-watering container and soil and hydrogel mixture comprising:
(a) A bottom having an aperture;
(b) an elliptical wall rising substantially vertically from the bottom and having a substantially horizontal upper edge forming an opening of the one-piece self-watering container, said elliptical wall defining an internal volume of the one-piece self-watering container;
(c) a layer of rocks disposed on the bottom in the internal volume;
(d) a filter disposed on the layer of rocks in the internal volume; and
(e) a soil and hydrogel mixture comprising 2.5 to 3.0 pounds of hydrogel per approximately 1.25 cubic feet of soil disposed on top of the filter in the internal volume.

22. The one-piece self-watering container and soil and hydrogel mixture of claim 21, further comprising attachment means securing the filter to the elliptical wall so as to close any gaps between the filter and the elliptical wall.

23. The one-piece self-watering container and soil and hydrogel mixture of claim 22, wherein the attachment means are selected from a group consisting of thermal bonding, adhesive, duct tape, double-sided tape, hook and loop fasteners, buttons, snaps, stops, screws, bolts, latches, locks, straps, and rails.

24. The one-piece self-watering container and soil and hydrogel mixture of claim 21, wherein the layer of rocks is one to two inches thick.

25. The one-piece self-watering container and soil and hydrogel mixture of claim 21, wherein the soil and hydrogel mixture is loaded into the one-piece self-watering container through the opening.

26. The one-piece self-watering container and soil and hydrogel mixture of claim 21, wherein the elliptical wall is tapered to facilitate stacking of multiple empty containers.

27. The one-piece self-watering container and soil and hydrogel mixture of claim 21, further comprising a cooperating top cover fitted to the opening.

28. The one-piece self-watering container and soil and hydrogel mixture of claim 21, wherein the filter is a polyester pad.

29. The one-piece self-watering container and soil and hydrogel mixture of claim 21, wherein the interior volume is 13 gallons and wherein the soil and hydrogel mixture includes approximately 1.25 cubic feet of soil and 2.5 pounds of hydrogel, leaving seven to nine inches of space at the top of the interior volume for expansion of the soil and hydrogel mixture when the one-piece self-watering container is filled with water.
